(19) United States
(12) Patent Application Publication
(10) Pub. No.: US 2010/0239115 A1
(43) Pub. Date: Sep. 23, 2010

(54) HEADSET ACCESSORY DEVICE SYSTEM

(75) Inventor: James D. Richardson, Corvallis, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: NaturalPoint, Inc., Corvallis, OR (US)

(21) Appl. No.: 12/405,851

(22) Filed: Mar. 17, 2009

(51) Int. Cl. H04R 25/00

(52) U.S. Cl. 381/384; 381/370

(57) ABSTRACT

A headset system is provided. The headset system includes a speaker assembly to produce sound based on an audio signal, an attachment portion configured to orient the at least one speaker assembly proximate to an ear of a user such that the sound is directed substantially toward the ear of the user, and a mounting interface configured to interchangeably receive one of a plurality of accessory devices, wherein the plurality of accessory devices each have a mechanical coupling configuration compatible with the mounting interface.

### TECHNICAL FIELD

The present description relates to a headset wearable by a user and, more particularly, to a headset configured to interchangeably receive one of plurality of accessory devices.

### BACKGROUND

Audio headsets are often used in connection with personal computers and other computing and electronic devices. Such headsets commonly include one or more speakers and a microphone, and may be used in a variety of ways with the connected device. For example, a user may wear a headset while communicating with another individual on a telephone, listening to music on a portable music player, playing a video game on a personal computer or video game console, etc. Despite wide availability from a variety of manufacturers, typical audio headsets for use with consumer electronics are, for all practical purposes, limited to the functionality provided by the conventional speakers and microphone described above.

### BRIEF DESCRIPTION OF THE DRAWINGS

FIG. 1 is a schematic view of a block diagram of a headset system of the present disclosure.

FIG. 2 is a front view of an embodiment of a headset system configured to receive one of a plurality of accessory devices.

FIG. 3 is a front view of another embodiment of a headset system configured to receive a plurality of accessory devices.

FIG. 4 is a perspective view of yet another embodiment of a headset system configured to secure to an ear of a user.

FIG. 5 is a front view of an embodiment of an accessory device mounting accessory of the present disclosure.

### DETAILED DESCRIPTION

The present description is directed to a wearable headset system for providing audio output and other functionality to a user. The headset system may include an interface configured to cooperate with one or more accessory devices that may enhance the experience of the user and may improve the usability and convenience of the accessory device and/or the headset system. The description is broadly applicable to use settings where the headset system and the accessory device(s) interact with a computing device (e.g., computer, audio device, portable telephone, personal digital assistant, etc.). For example, the headset system may include or cooperate with an accessory device that forms part of a position sensing system configured to generate an output which varies in response to changes in position. The output of the position sensing system may be used to control the computing device. In one particular example, the headset system may include a sensor or sensed beacon that may be used to determine the position of the headset system, and correspondingly, the head of a user wearing the headset system. The position and movement of the user's head may generate input to control the computing device. For example, the movement of the user's head may control presentation of a rendered scene of a virtual reality video game.

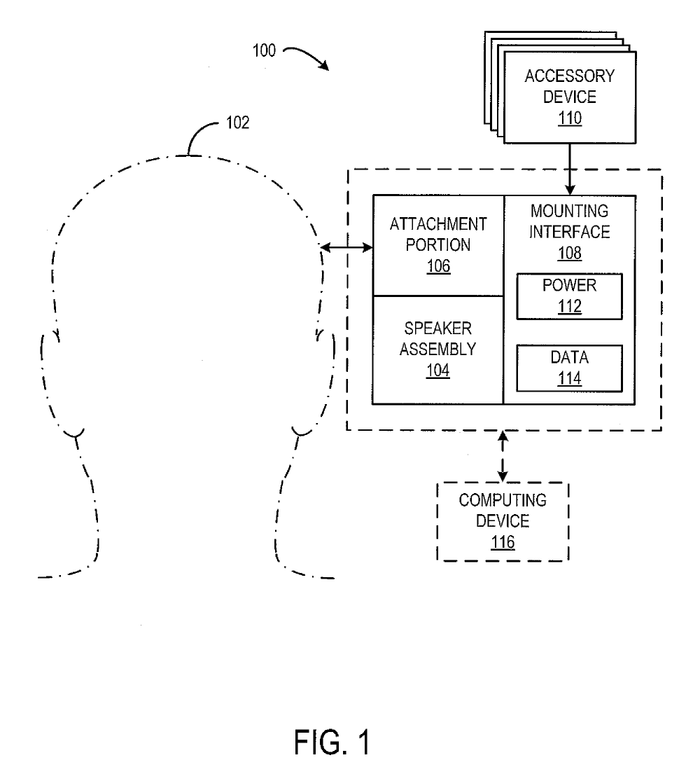

FIG. 1 schematically depicts a headset system 100 according to the present disclosure. Headset system 100 may be configured to be worn by a user 102. Headset system 100 may include a speaker assembly 104, an attachment portion 106, and a mounting interface 108 configured to interchangeably receive one or more of a plurality of accessory devices 110.

Speaker assembly 104 may be configured to provide sound to user 102 based on an audio signal. The audio signal may be received by the speaker assembly from virtually any suitable audio-signal-producing device in communication with the speaker assembly, such as for example, computing device 116. Speaker assembly 104 may be in wired or wireless communication with computing device 116. Further, speaker assembly 104 may be powered by electrical power received from computing device 116. In some embodiments, the speaker assembly may be powered by another source such as a battery or an electrical power receptacle.

Speaker assembly 104 may include virtually any suitable sound-producing technology and may deliver sound to user 102 in virtually any suitable manner. For example, the speaker assembly may be circum-aural having a circular shape that fits around the ear. As another example, the speaker assembly may be supra-aural having pads that sit on an outer surface of the ear, rather than around the ear. As yet another example, the speaker assembly may be earphones that rest in the outer part of the ear canal. As still yet another example, the speaker assembly may be canal phones that extend into the ear canal.

In some embodiments, the headset system may include two speaker assemblies one corresponding to the right ear and the other corresponding to the left ear (e.g., a stereo audio system). In some embodiments, the headset system may include only one speaker assembly configured to provide sound to a particular ear (i.e., the right ear or the left ear).

Speaker assembly 104 may be positioned proximate to an ear of the user via attachment portion 106. In one example, the attachment portion is shaped to fit over the top of the user's head and secures the speaker assembly proximate to the ear via tension of the attachment portion to the user's head. In another example, the attachment portion is shaped to fit over the top of and rest on the user's ear orientating the speaker assembly to provide sound to the user's ear. As another example, the attachment portion wraps around the back of the user's head and the tension of the speaker assembly in the user's ear holds the headset in place.

In some embodiments, a speaker assembly may be connected to each end of the attachment portion so that a speaker assembly may be provided for each ear of the user. In some embodiments, the attachment portion may be articulated or may include a pivot to allow for easy placement of the headset on the user's head. Further, in some embodiments, the attachment portion may be adjustable to fit the head or ear of various different users.

Mounting interface 108 may be configured to interchangeably receive one or more of a plurality of accessory devices 110 that may be used in cooperation with the headset system. An accessory device may be received by the mounting interface and secured to the headset system in virtually any suitable manner. Examples of a manner in which an accessory device may communicate with the mounting interface include a mechanical coupling such as a latch or clip, a tension socket or rail, a magnetic connection, etc. Alternatively or additionally, an accessory device may be integrally formed with the headset system, such that it is not removable.

Mounting interface 108 may include an electrical power receptacle 112 to supply power to an accessory device secured in the mounting interface. In some embodiments, the electrical power receptacle may receive electrical power internal to the headset system which may be transmitted to the accessory device. For example, the headset system may be in communication with a computing device. Electrical power may be transmitted from the computing device to the headset system and the electrical power may be provided to the accessory device via the electrical power receptacle. This example may be particularly applicable to low-consumption accessory devices. In some embodiments, the electrical power receptacle may receive electrical power external of the headset system which may be transmitted to the accessory device. For example, the mounting interface may include a electrical power chord that may be plugged into an external receptacle. Electrical power may be transmitted from the external receptacle to the mounting interface and provided to the accessory device. This example may be particularly applicable to high-consumption accessory devices. Examples of high-consumption devices that may utilize electrical power from an external source may include a multi-color display device, a camera, an external speaker, etc.

Mounting interface 108 may include a data-connection receptacle 114 to transfer data between one of a plurality of accessory devices 110 and headset system 100 and/or computing device 116 in communication with the headset system. Virtually any suitable data transfer standard and/or technology may be implemented for data transmission via data connection receptacle 114. Examples of transmission standards and/or technologies that may be implemented in the data connection receptacle may include universal serial bus (USB), FireWire, small computer communication interface (SCSI), serial, parallel, etc.

It will be appreciated that in some embodiments, an electrical power and/or data communication receptacle may be omitted from the mounting interface. Further, in some embodiments, electrical power and data communications may be transferred by the same receptacle.

The mounting interface may be positioned on the attachment portion of the headset system. For example, the attachment portion may be configured to extend over the top of the user's head and the mounting interface may be at the apex of the attachment portion, as such, an accessory device that is secured to the mounting interface is positioned above the user's head. In one particular example, an external lighting effects device is securable to a mounting interface positioned on an attachment portion above the top of the user's head to provide lighting effects that are perceived by the peripheral vision of the user.

The mounting interface may be positioned on the speaker assembly of the headset system (i.e., instead of being positioned on the attachment portion). By positioning the mounting interface with the speaker assembly, electrical power and data communication may be supplied to the speaker assembly and the mounting interface via the same transmission lines. In one particular example, an accessory device is affixed to a mounting interface of a headset system that is positioned adjacent a speaker assembly. The accessory device includes a display that is viewable by the user. The head set system includes transmission lines grouped in a cable that connects to a computer. Data is sent from the computer to the headset via the transmission lines. In particular, the computer sends audio data to the speaker assemblies and video data to the mounting interface which further transmits it to the display of the accessory device. Furthermore, the computer transmits electrical power on the transmission lines to power the speaker assemblies and the display of the accessory device via the mounting interface.

In some embodiments, the mounting interface and the accessory device may have complimentary male/female type connectors which may interact to secure the accessory device to the mounting interface. It will be appreciated that each of the plurality of accessory devices that may be used with the headset system may have the same type of connector that is compatible with the mounting interface. In this way, each of the plurality of accessory devices may be interchangeable and selectively used with the headset system.

Furthermore, in some embodiments, the mounting interface may include a plurality of mounting ports. Each mounting port may be configured to communicate with an accessory device. In particular, each mounting port may include an electrical power and/or data communication receptacle to optionally transmit power and data to an accessory device. In this way, multiple accessory devices may interact with the headset system at the same time.

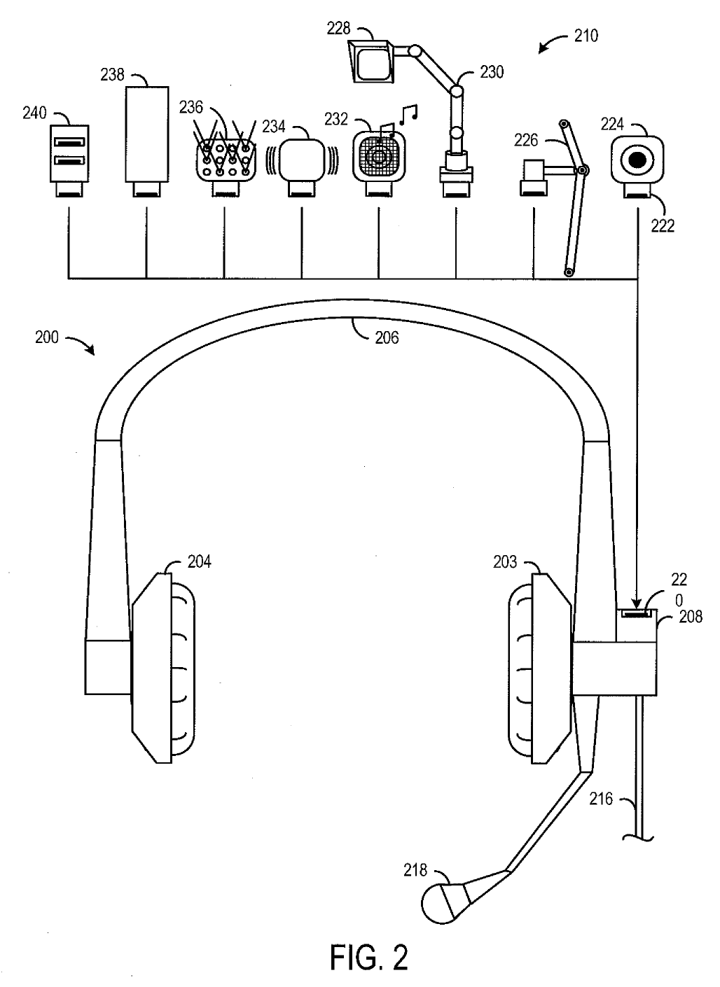

Turning to FIG. 2, an embodiment of a headset system including a mounting interface configured to interchangeably receive one of a plurality of accessory devices is shown. Headset system 200 includes a first speaker assembly 203 and a second speaker assembly 204 joined by an attachment portion 206. In this example, the first and second speaker assemblies are circum-aural type speakers that are configured to fit around the ears of a user and the attachment portion is shaped to fit over the head of the user such that the attachment portion rests on the head of the user.

As discussed above, a user may wear the headset system in order to interact with a computing device. Moreover, a user may interact with other users via the computing device. Thus, headset system 200 includes a microphone 218 that a user may speak into to communicate with other users or to provide vocal input to a computing device. Feedback from the computing device and/or other users may be provided to the user via the speaker assemblies 203 and 204.

Microphone 218 may be selectively used based on the activity in which the user is participating. Thus, microphone 218 may be articulated or flexibly connected to the headset system so that the microphone may be moved proximate to the mouth of the user for a speaking situation or the microphone may be moved away from the mouth of the user so as not to impede the user. In some embodiments, the microphone may be selectively removable from the headset system. In some embodiments, the microphone may be omitted from the headset system.

Headset system 200 includes mounting interface 208 positioned adjacent second speaker assembly 203. Mounting interface may be configured to interchangeably receive one of a plurality of accessory devices 210 each of which have a mechanical coupling configuration compatible with the mounting interface. In the illustrated embodiment, mounting interface 208 has a female type socket 220 that is configured to receive a male type plug, such as plug 222 of camera 224, for example. Each of plurality of accessory devices 210 have a plug (e.g., plug 222 of camera 224) which is compatible with socket 220. Accordingly, each of the plurality of accessory devices may be interchangeably secured to the mounting interface via the socket plug configuration so that a selected one of the plurality of accessory devices may be cooperatively used with the headset system.

Mounting interface 208 may provide electrical power and/or data transmission capabilities to a secured accessory device via socket 220. Electrical power and/or data transmission capabilities may be provided to headset system 200 via transmission line 216. In one particular example, the socket is a universal serial bus port that is configured to receive a universal serial bus plug of one of the plurality of accessory devices to facilitate communication between one of the plurality of accessory devices and the headset system and/or a computing device.

Furthermore, transmission line 216 may be configured to plug into a computing device or other power generating device (not shown). In particular, transmission line 216 may provide an audio signal to speaker assemblies 203 and 204, and electrical power and/or data signals to mounting interface 208. Further, transmission line 216 may send audio signals generated by microphone 218, and data signals generated by an accessory device secured to mounting interface 208 to a computing device (not shown). In some embodiments, the headset system may include a separate electrical power transmission line and data transmission line. In some embodiments, the headset system may communicate with a computing device via wireless transmissions.

A variety of different accessory devices may be secured to the mounting interface to enhance the experience of the user. For example, a sensor or sensed beacon may be secured to the mounting interface to form a part of a position sensing system configured to generate an output which varies in response to changes in position. In particular, the position of the sensor or sensed beacon may be determined relative to a predetermined position that may be used to control a computing device. Camera 224 is an example of an optical type sensor that may be used to track the position/movement of the user's head. In one example, the camera may receive electrical power from the mounting interface and may send a video signal to a computing device via the mounting interface. An infrared light emitting diode (LED) array 226 is an example of a sensed beacon that may be recognized by a optical sensor to track the position/movement of the user's head. Infrared LED array 226 may include three LEDs having fixed positions relative to one another and to the headset system. In one example, the LEDs of the array are powered by electrical power from the mounting interface. In another example, the LEDs of the array are powered by an external power source, such as a battery. It will be appreciated that other accessory devices having different types of sensors and/or sensed beacons may be used to determine position/movement of the user's head to control a computing device.

As another example, an accessory display device 228 may be secured to mounting interface 208. Accessory display device 228 may include an articulated region 230 to align the display device with an eye of the user. Accessory display device 228 may be configured to present information received from a computing device via mounting interface 208 to the user. For example, a user may view content presented by a computing device and the display device may present additional content that supplements the content presented by the computing device. In one particular example, where the user is playing a first person shooter virtual reality video game, the user views a standard first person view on a display of a computing device and the accessory display device selectively presents a zoomed-in view, such as from the perspective of a sniper scope. This is one example of content presentable by the accessory display device and it will be appreciated that other types of content may be presented by the accessory display device.

As yet another example, a supplemental speaker device 232 may be secured to mounting interface 208. Supplemental speaker device 232 may provide supplemental or directed sound effects to enhance the audio experience of the user. For example, a primary audio signal may be sent to the speaker assemblies and a secondary audio signal may be sent to the supplemental speaker via the mounting interface. In one particular example, the speaker may be used to create surround sound effects that are locally directed to the user.

As yet another example, a haptic feedback device 234 may be secured to mounting interface 208. Haptic feedback device 234 may generate vibrations or rumbling effects to enhance the tactile experience of the user. For example, the haptic feedback device may receive a control signal from a computing device via the mounting interface to generate vibrations in cooperation with a software application running on the computing device. In one particular example, where the user is playing an automobile racing simulation video game, the haptic feedback device generates vibrations in response to a virtual automobile encountering a rough road surface.

As yet another example, a lighting device 236 may be secured to mounting interface 208. Lighting device 236 may provide lighting effects to enhance the visual experience of the user. The lighting device may include one or more lights which may be selectively toggled to produce lighting effects. In the illustrated embodiment, lighting device 234 includes an array of LEDs, different combinations of which may be selectively toggled to generate different lighting effects. For example, the lighting device may receive a control signal from a computing device via the mounting interface to generate various lighting effect by toggling on and off combinations of LEDs. In one particular example, visual effects are generated by the lighting device that are complimentary to music generated by the speaker assemblies.

As yet another example, a storage device 238 may be secured to mounting interface 208. Storage device 238 may communicate with headset system 200 and/or a computing device to upload/download data via mounting interface 208. For example, data stored on the storage device may be downloaded to the computing device via the mounting interface. Likewise, data stored on the computing device may be uploaded to the storage device via the mounting interface. In one particular example, a user's customized video game settings are stored on the storage device and the settings are downloaded to a computing device via the headset system to customize the gaming experience of the user.

Storage device 238 may include virtually any suitable type of memory. In one example, the storage device may include non-volatile memory, such as flash memory. By permitting the storage device to connect with the headset system and/or a computing device via the mounting interface, convenience of data transfer may be improved relative to plugging a storage device into the back of a computing device.

As yet another example, an accessory device hub 240 may be secured to mounting interface 208. Accessory device hub 240 may include additional accessory device ports, each port having a socket to receive an accessory device. The sockets of the accessory device hub may be the same type of socket as the mounting interface. Accessory device hub 240 may include arbitration logic circuits to control electrical power and/or data transmission to each of the ports of the accessory device hub.

It will be appreciated that the above described accessory devices are examples and other types of accessory device may be secured to the mounting interface to interact with the headset system and/or a computing device without departing from the scope of the present disclosure.

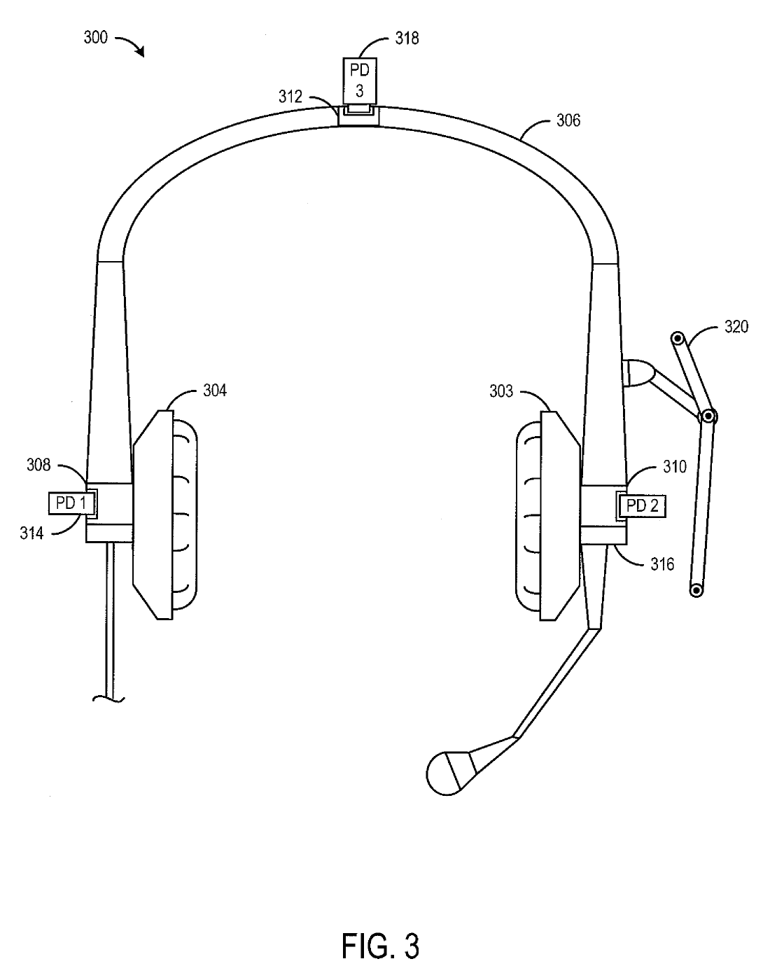

Turning to FIG. 3, another embodiment of a headset system having a plurality of mounting interfaces is shown. Headset system 300 may include a first mounting interface 308 that is incorporated with a first speaker assembly 304, a second mounting interface 310 that is incorporated with a second speaker assembly 303, and a third mounting interface 312 that is incorporated with an attachment portion 306. Each of mounting interfaces 308, 310, and 312 may be configured to interchangeably receive one of a plurality of different accessory devices. As illustrated, a first accessory device 314 may be secured to first mounting interface 308, a second accessory device 316 may be secured to second mounting interface 310, and a third accessory device 318 may be secured to third mounting interface 312. The first, second, and third accessory devices have the same type of mechanical coupling that is compatible with the first, second, and third mounting interfaces. Thus, each of the accessory devices may be interchangeably mounted to each of the mounting interfaces. Since the headset system includes a plurality of mounting interfaces more than one accessory device may be used in cooperation with the headset system at one time.

Furthermore, because the various mounting interfaces are located at different positions on the headset system, the headset system provide flexibility on choosing where an accessory device may be positioned. For example, a user may choose to secure an accessory device on a particular mounting interface based on comfort. In one particular example, an accessory device is secured to a mounting interface opposite of a microphone so that the user perceives that the headset is balanced. As another example, a user may choose to secure an accessory device on a particular mounting interface based on accessibility or convenience. In one particular example, a user secures a portable storage device (e.g., a jump drive) to a mounting interface positioned on the dominant-hand side of the user (e.g., right hand or left hand) to quickly upload a user profile for a video game. Mounting interfaces may be located on both sides of the headset system to enable natural and intuitive use by both right-hand and left-hand dominant users.

It will be appreciated that a headset system may include virtually any suitable number of mounting interfaces that may be located at virtually any suitable position of the headset system.

In some embodiments, one or more accessory devices may be integrated into the headset system such that they are not interchangeable for other accessory devices. As shown in FIG. 3, headset system 300 may be used for position sensing and thus includes a sensed beacon 320 integrated into attachment portion 306. Sensed beacon 320 may include three sensed locations fixed relative to each other in an array that is in a position that is fixed relative to a user's head. In some embodiments, the sensed beacon may be energized by electrical power in order to be tracked. Since the sensed beacon is integrated into the headset system, the speaker assembly and the sensor may be configured to receive electrical power from a shared power source, such as a transmission line connected to the headset.

In one example, the position of the sensed beacon is detected by a sensor and the sensed position is used to track a position of the user's head relative to a predetermined position in order control a computing device. It will be appreciated that a sensed beacon may include virtually any suitable number of sensed locations. Further, the sensed beacon may be made of virtually any suitable material that is tracked.

In some embodiments, a headset system may include only one or more accessory devices that are integral with the headset system. Further, a mounting interface need not be included in the headset system to interchangeably receive one of a plurality of accessory devices.

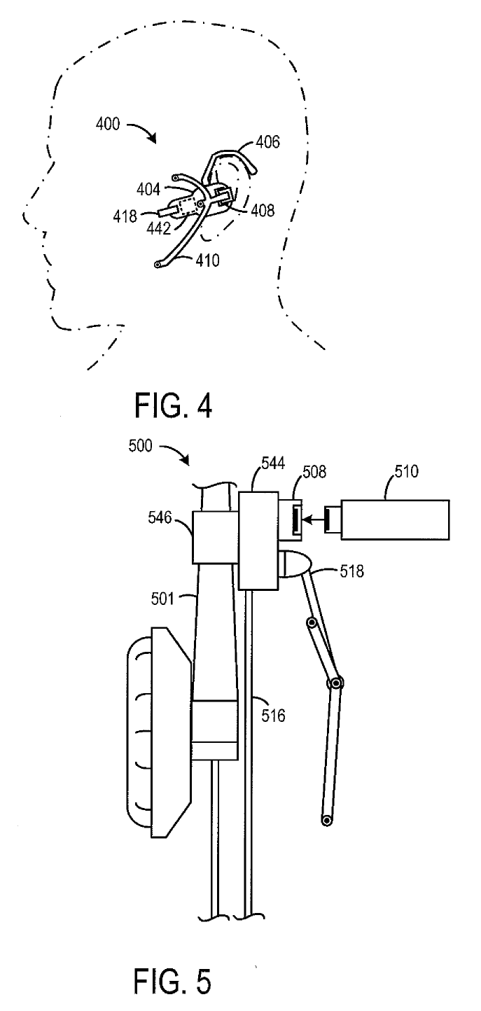

Turning to FIG. 4, another embodiment of a headset system that facilitates wireless communication is shown. Headset system 400 includes a single speaker assembly 404 and a microphone 418 that may be used to communicate with other users and/or computing devices. The communication may be sent via communication module 442. In one example, the communication module is a short range radio transceiver which may provide a way to connect and exchange information between devices over a short-range radio frequency.

Speaker assembly 404 may be coupled to attachment portion 406. Attachment portion 406 may be configured to extend over the top of a user's ear and may be curved to position speaker assembly 404 proximate to the user's ear. In some embodiments, the attachment portion may be moldable and/or pivotable in order to create a customized fit for a particular user's ear. Headset system 400 may include mounting interface 408 configured to interchangeably receive one of a plurality of accessory devices. In the illustrated embodiment, a sensed beacon 410 is secured to mounting interface 408.

Headset system 400 includes small and sleek components for a light weight, low profile, and minimalist design. Headset system 400 may be utilized to advantage in mobile applications or applications where audio quality is not prioritized. The low profile design of the headset system 400 may introduce weight and size restrictions to accessory devices that may be secured to the mounting interface 408. Accordingly, smaller, lighter, and low or no power consumption accessory devices may be utilized with headset system 400.

Turning to FIG. 5, an embodiment of an accessory device mounting apparatus is shown. The accessory device mounting apparatus may be configured to secure to a headset to provide a mounting interface to which one of a plurality of accessory devices that are compatible with the mounting interface may be secured to in order to enhance the functionality of the headset. The accessory device mounting accessory may be particularly applicable to legacy or stand alone headsets that do not include an integrated accessory device or a mounting interface to receive an accessory device.

Accessory device mounting apparatus 500 includes a frame 544 for stabilizing a mounting interface 508 and a sensed beacon 518 to headset 501. Frame 544 may be affixed to headset 501 via a headset coupling interface 546. Headset coupling interface 546 may include virtually any suitable type of coupling mechanism. Examples include straps, screws, clips, hook and loop fasteners, tension bars, etc. Headset coupling interface 546 may be configured to selectively affix and remove accessory device mounting apparatus 500 to headset 501. Once affixed to the headset, the accessory device mounting apparatus may be immobile so that an accessory device secured to the headset mounting accessory may be fixed relative to the headset. This may be particularly applicable for accurate position sensing operations.

As discussed above, sensed beacon 518 may be used to track a position of the user's head for the purpose of controlling a computing device. It will be appreciated that in some embodiments, the accessory device mounting accessory may include a sensor instead of (or in addition to) a sensed beacon to indicate a position of the headset relative to a predetermined position.

Furthermore, mounting interface 508 may be configured to interchangeably receive one of a plurality of accessory devices 510. Mounting interface 508 may include a data connection receptacle through which data may be transferred between the one of the plurality of accessory devices and a computing device in communication with the accessory device mounting Accessory device mounting apparatus. In one particular example, the data connection receptacle includes a universal serial bus port. Further, the data connection receptacle may be configured such that electrical power is supplied to the one of the plurality of accessory devices through the data connection receptacle. Accessory device mounting apparatus 500 may include transmission line 516 to transmit and/or receive electrical power and/or data communication between the accessory device mounting apparatus and a computing device or external electrical power receptacle. In some embodiments, transmission line 516 may connect to a transmission line of the headset in order to reduce the number of lines connecting the headset and accessory devices to a computer or electrical power receptacle. In some embodiments, the accessory device mounting apparatus need not have electrical and/or data communication receptacle(s), and thus the transmission line may be omitted. In some embodiments, the transmission line may be omitted in favor of a power supply that is internal to the accessory device mounting apparatus, such as a battery, for example.

It will be appreciated that the embodiments and method implementations disclosed herein are exemplary in nature, and that these specific examples are not to be considered in a limiting sense, because numerous variations are possible. The subject matter of the present disclosure includes all novel and nonobvious combinations and subcombinations of the various intake configurations and method implementations, and other features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A headset system comprising:
at least one speaker assembly to produce sound based on an audio signal;
an attachment portion configured to orient the at least one speaker assembly proximate to an ear of a user such that the sound is directed substantially toward the ear of the user; and
at least one mounting interface configured to interchangeably receive one of a plurality of accessory devices, wherein the plurality of accessory devices each have a mechanical coupling configuration compatible with the mounting interface.

2. The system of claim 1, wherein the at least one mounting interface includes an electrical power receptacle through which electrical power is supplied to the one of the plurality of accessory devices.

3. The system of claim 1, wherein the at least one mounting interface includes a data connection receptacle through which data is transferred between the one of the plurality of accessory devices and a computing device in communication with the headset system.

4. The system of claim 1, wherein the at least one mounting interface includes a plurality of mounting ports, each of the plurality of mounting ports being configured to communicate with an accessory device.

5. The system of claim 1, wherein the one of the plurality of accessory devices form part of a position sensing system configured to generate an output which varies in response to changes in position.

6. The system of claim 5, wherein the one of the plurality of accessory devices includes at least one of a sensor and a sensed beacon to indicate the position of the accessory device relative to a predetermined position.

7. The system of claim 6, wherein the sensed beacon includes a fixed array of at least three infrared light emitting diodes.

8. The system of claim 1, wherein the at least one mounting interface includes a universal serial bus port to receive a universal serial bus plug of one of the plurality of accessory devices to facilitate communication between the one of the plurality of accessory devices and a computing device.

9. The system of claim 1, wherein the mounting interface is positioned on the at least one speaker assembly.

10. The system of claim 1, wherein the mounting interface is positioned on the attachment portion.

11. The system of claim 1, further comprising:
a microphone coupled to the at least one speaker assembly.

12. A headset system comprising:
at least one speaker assembly to produce sound based on an audio signal;
an attachment portion configured to orient the at least one speaker assembly proximate to an ear of a user such that the sound is directed substantially toward the ear of the user; and
a positioning accessory device that forms part of a position sensing system configured to generate an output which varies in response to changes in position.

13. The system of claim 12, wherein the positioning accessory device includes at least one of a sensor and a sensed beacon to indicate the position of the accessory device relative to a predetermined position.

14. The system of claim 12, further comprising:
a mounting interface configured to interchangeably receive one of a plurality of accessory devices.

15. The system of claim 14, wherein the one of the plurality of accessory devices is selected from a group consisting of a lighting effect device, one or more external speakers, a haptic feedback device, a storage device, and a display device.

16. The system of claim 14, wherein the one of the plurality of accessory devices includes at least one articulated region to facilitate rotation of the one of the plurality of accessory devices about the headset system.

17. An accessory device mounting apparatus comprising:
a frame;
a headset coupling interface configured to removably affix the frame to a headset wearable by a user; and
at least one mounting interface affixed to the frame and configured to interchangeably receive one of a plurality of accessory devices.

18. The apparatus of claim 17, further comprising:
at least one of a sensor and a sensed beacon to indicate a position of the headset relative to a predetermined position.

19. The apparatus of claim 17, wherein the at least one mounting interface includes a data connection receptacle through which data is transfer between the one of the plurality of accessory devices and a computing device in communication with the accessory device mounting apparatus.

20. The apparatus of claim 19, wherein the data connection receptacle is further configured such that electrical power is supplied to the one of the plurality of accessory devices through the data connection receptacle.
